(19) United States
(12) Patent Application Publication
(10) Pub. No.: US 2015/0312981 A1
(43) Pub. Date: Oct. 29, 2015

(54) CURRENT ADJUSTING DEVICE AND ADJUSTMENT METHOD THEREOF

(71) Applicant: Shenzhen China Star Optoelectronics Technology Co., Ltd., Shenzhen (CN)

(72) Inventors: Hua ZHANG, Shenzhen (CN); Fei LI, Shenzhen (CN)

(21) Appl. No.: 13/813,454

(22) PCT Filed: Jan. 29, 2013
(86) PCT No.: PCT/CN2013/071077

§ 371 Date: Jan. 31, 2013

(30) Foreign Application Priority Data
Jan. 22, 2013 (CN) 201310023245.1

(51) Int. Cl. H05B 33/08

(52) U.S. Cl. CPC H05B 33/0815; H05B 33/0812; H05B 33/089

(57) ABSTRACT

A current adjusting device is disclosed herein. The current adjusting device is utilized for adjusting a value of a current outputted into a load. The current adjusting device comprises a constant current driving unit and a boosting circuit. The constant current driving unit is electrically connected with a negative terminal of the load and a first resistor respectively, and the constant current driving unit comprises a comparing module and a first switch module, such that the constant current driving unit detects a voltage of the negative terminal of the load and outputs a boost signal. The constant current driving unit receives a PWM signal to control a close or an open of the first switch module for controlling a waveform of a load current, and the constant current driving unit receives an input voltage having an adjustable duty cycle to form a reference voltage and adjusts an impedance of the first switch module by comparing the reference voltage and a voltage on the first resistor by the comparing module to determine the current value of the load. The boost circuit, which is electrically connected with a positive terminal of the load and an external power source, boosts an external voltage provided by the external power source to drive the load according to the boost signal.

### TECHNICAL FIELD OF THE INVENTION

The present invention relates to a field of current adjustment, and more particularly to, a current adjusting device which is applicable for adjusting a value of a current outputted into a load.

### BACKGROUND OF THE INVENTION

The LED (Light-Emitting Diode) technology is becoming more matured as the LEDs are widely applied in many products and different fields, such that the LEDs are becoming an indispensable item for people.

However, driving devices used to drive the LEDs are still a technology field to be noted. A direct current utilized to drive the LEDs can allow the LEDs to have better lighting efficiency; therefore most of the driving devices are now driving LEDs with direct current driving mechanism. As most of the current values for driving the LEDs are set when they are designed, foreseeable situations such as the driving current cannot be adjusted, will cause excess energy consumption, thereby not complying with the requirements of energy conservation.

Therefore, developing a technique for solving above-mentioned problem is urgently needed.

### SUMMARY OF THE INVENTION

An objective of the present invention is to provide a current adjusting device and an adjustment method thereof so as to adjust a value and a duty cycle of a load current, simultaneously.

To solve the above-mentioned problem, the present invention provides a current adjusting device which is used for adjusting a current value outputted to a load. The current adjusting device comprises an ADIM (analog dimming input) voltage input unit and a constant current driving unit. The ADIM voltage input unit is utilized for providing an ADIM voltage, and a waveform of which is a pulse waveform having an adjustable duty cycle and filtered to a DC voltage. The constant current driving unit is electrically connected with the ADIM voltage input unit, a negative terminal of the load, and a first resistor, respectively, and the constant current driving unit comprises a comparing module and a first switch module. The constant current driving unit receives the ADIM voltage having the adjustable duty cycle to form a reference voltage, and the constant current driving unit adjusts an impedance of the first switch module by the comparing module comparing the reference voltage and a voltage on the first resistor to determine the current value of the load.

In the above-mentioned current adjusting device, the current adjusting device further comprises a PWM (pulse width modulation) signal input unit which is electrically connected with the constant current driving unit and used for inputting a PWM signal to the constant current driving unit, so that the constant current driving unit receives the PWM signal to control a close or an open of the first switch module for controlling a waveform of the load current.

In the above-mentioned current adjusting device, the current adjusting device further comprises a circuit divider which is used for dividing the DC voltage into the reference voltage.

In the above-mentioned current adjusting device, the current adjusting device further comprises a boost circuit which is electrically connected with a positive terminal of the load and an external power source, and the constant current driving unit detects a voltage of the negative terminal of the load and accordingly outputs a boost signal having a duty cycle to boost an external voltage provided by the external power source to drive the load, wherein the duty cycle of the boost signal is adjusted based on the voltage detected on the negative terminal of the load by the constant current driving unit.

To solve the above-mentioned problem, the present invention provides a current adjusting device which is used for adjusting a current value outputted to a load, and the current adjusting device comprises a constant current driving unit, and a boost circuit. The constant current driving unit is electrically connected with a negative terminal of the load and a first resistor, respectively, and the constant current driving unit comprises a comparing module and a first switch module. The constant current driving unit detects a voltage of the negative terminal of the load and accordingly outputs a boost signal, and the constant current driving unit receives a PWM signal to control a close or an open of the first switch module for controlling a waveform of the load current, and the constant current driving unit receives an input voltage having an adjustable duty cycle to form a reference voltage and adjusts an impedance of the first switch module by the comparing module comparing the reference voltage and a voltage on the first resistor to determine the current value of the load. The boost circuit is electrically connected with a positive terminal of the load and an external power source, and boosts an external voltage provided by the external power source to drive the load according to the boost signal.

In the above-mentioned current adjusting device, the current adjusting device further comprises a circuit divider which is used for dividing the input voltage into the reference voltage.

In the above-mentioned current adjusting device, the current adjusting device further comprises a voltage input unit and a PWM signal input unit. The voltage input unit is electrically connected with the constant current driving unit and is used for inputting the input voltage as a pulse waveform having an adjustable duty cycle to the constant current driving unit. The PWM signal input unit is electrically connected with the constant current driving unit and used for inputting the PWM signal to the constant current driving unit.

In the above-mentioned current adjusting device, the voltage input unit comprises a second filter circuit utilized to filter the pulse waveform inputted to the constant current driving unit.

In the above-mentioned current adjusting device, the constant current driving unit detects the voltage on the negative terminal of the load and accordingly outputs the boost signal having a duty cycle to the boost circuit according to the voltage detected on the negative terminal of the load, and the duty cycle of the boost signal is adjusted based on the voltage detected on the negative terminal of the load by the constant current driving unit.

To solve the above-mentioned problem, the present invention provides a current adjusting method, for adjusting a current value outputted to a load, and the current adjusting method comprises the following: boosting an external voltage to a voltage level which is enough to drive the load; forming a reference voltage by receiving an input voltage having an adjustable duty cycle; detecting a voltage on a first resistor electrically connected with the load through a constant current driving unit; and comparing the reference voltage and the voltage on the first resistor to adjust the current value of the load.

In the above-mentioned current adjusting method, the input voltage is a pulse waveform having an adjustable duty cycle.

In the above-mentioned current adjusting method, the pulse waveform is formed by filtering.

In the above-mentioned current adjusting method, the method further comprises: controlling a waveform of the current of the load by a PWM signal.

The current adjusting device and method of the present invention can achieve double adjusting of the input voltage and the PWM signal, so that the value and duty cycle of the load current can be adjusted linearly, and various combination of current value and duty cycle are acted in concert with, various values and duty cycles of the load current can be obtained.

For better understanding of the aforementioned content of the present invention, the preferred embodiments are described in detail in conjunction with the appending figure as follows.

### BRIEF DESCRIPTION OF THE DRAWINGS

FIG. 1 illustrates a function block diagram of a current adjusting device according to one embodiment of the present invention;

FIG. 2 illustrates a circuit diagram of the current adjusting device as shown in FIG. 1;

FIG. 3 illustrates a flow chart of a current adjusting method according to another embodiment of the present invention.

### DETAILED DESCRIPTION OF THE INVENTION

Hereinafter, exemplary embodiments of the present invention will be described with reference to the accompanying drawings.

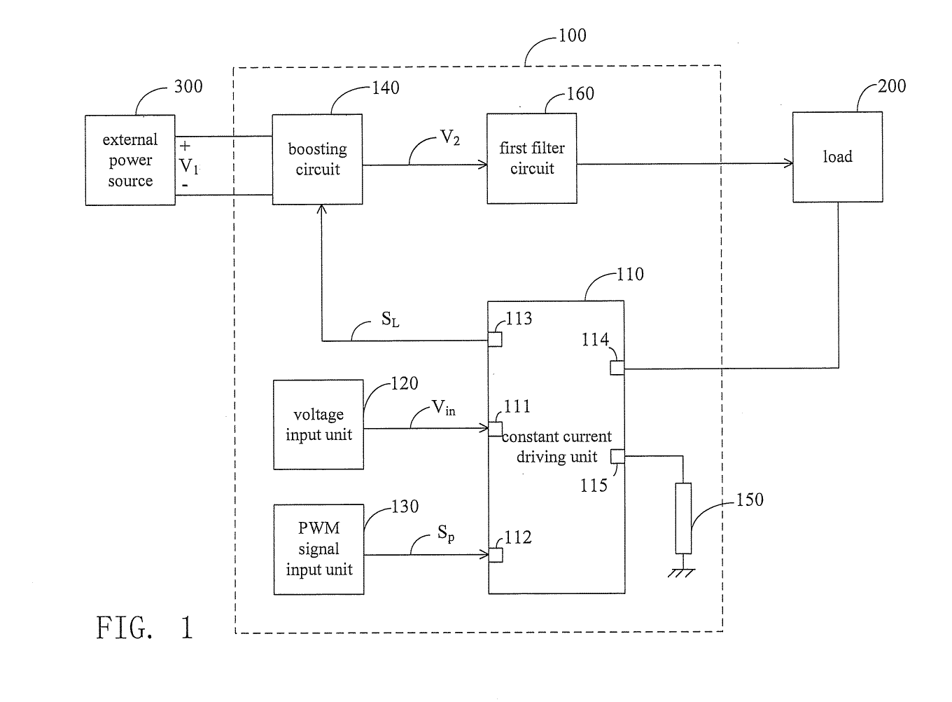

Please refer to FIG. 1. FIG. 1 illustrates a function block diagram of a current adjusting device according to one embodiment of the present invention. In the present invention, the current adjusting device 100 is utilized for driving a load 200, and a current value of the current is adjusted through the load 200. In this embodiment, the load 200 is not limited to be an LED string. The current adjusting device 100 comprises a constant current driving unit 110, a voltage input unit 120, a PWM signal input unit 130, and a boosting circuit 140. In this embodiment, external parts of the constant current driving unit 110 comprises a voltage input terminal 111, a signal input terminal 112, a signal output terminal 113, a first terminal 114, and a second terminal 115. The voltage input unit 120 is electrically connected with the voltage input terminal 111. The PWM signal input unit 130 is electrically connected with the signal input terminal 112. The boosting circuit 140 is electrically connected with a positive terminal of the load 200, the signal output terminal 113, and an external power source 130. The first terminal 114 is electrically connected with a negative terminal of the load 200, and the second terminal 115 is electrically connected with a first resistor 150.

At the time the external power source 300 provides a first driving voltage V₁ to the current adjusting device 100, if the impedance of the load 200 is too high, the first driving voltage V₁ cannot drive the load 200 directly, and the constant current driving unit 110 detects a voltage of the negative terminal of the load 200 by the first terminal 114. Because the load 200 is not driven, the voltage of the negative terminal of the load 200 is zero. The constant current driving unit 110 outputs a boosting signal S_{L} to the boosting circuit 140 through the signal output terminal 113, and when the boosting circuit 140 receives the boosting signal S_{L}, the boosting circuit 140 will boost the first driving voltage V₁ to a second driving voltage V₂ which is enough to drive the load 200.

In this embodiment, the boosting signal S_{L} is a signal having a duty cycle, when the boosting signal S_{L} is at a high level, the boosting circuit 140 is charged and the first driving voltage V₁ is boosted, when the first driving voltage V₁ is boosted to the second voltage V₂ which is enough to drive the load 200, the boosting signal S_{L} is switched into a low level, so that the boosting circuit 140 is discharged to drive the load 200. When the boosting circuit 140 is discharged to drive the load 200, the voltage of the boosting circuit 140 is decreased gradually, when the voltage of the boosting circuit 140 is decreased, and thus it is not enough to drive the load 200, the boosting signal S_{L} is switched to a high level, and the boosting circuit 140 is charged again to boost the voltage. Therefore, the high level and the low level of the boosting signal S_{L} is formed as a signal having a fixed duty cycle.

In this embodiment, the current adjusting device 100 further comprises a first filter circuit 160, which is disposed between the boosting circuit 140 and the load 200, and the first filter circuit 160 is utilized for filtering the second driving signal V₂ for enabling the second driving signal V₂ to be more stable.

In this embodiment, through the voltage input unit 120 and the PWM signal input unit 130, the constant current driving unit 110 can receive an input voltage Vᵢₙ to form a reference voltage V and receive a PWM signal S_{P}, and the constant current driving unit 110 detects a voltage on the first resistor 150, so that a current value of a load current I_{L} can be determined by comparing the reference voltage V and the voltage on the first resistor 150, in addition, a waveform of the load current I_{L} can be controlled through the PWM signal S_{P}, so that the load current I_{L} can be adjusted to various values and duty cycles.

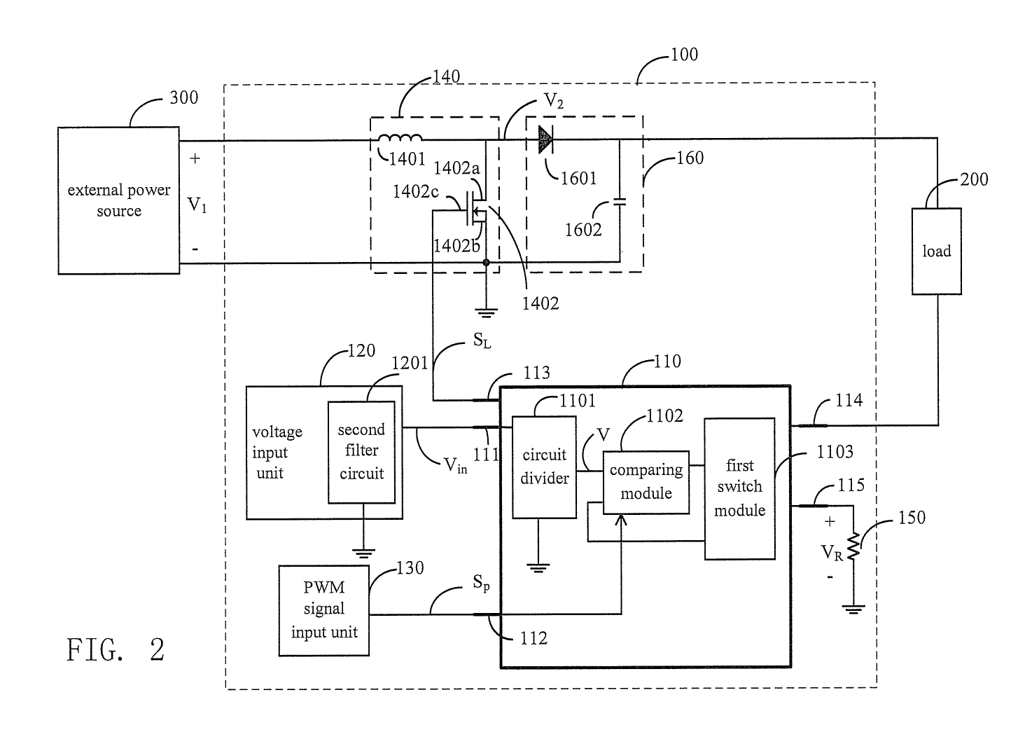

Please refer to FIG. 2 in conjunction with FIG. 1. FIG. 2 illustrates a circuit diagram of the current adjusting device as shown in FIG. 1. In this embodiment, the boosting circuit 140 comprises an inductor 1401 and a second switch module 1402, and the second switch module 1402 has a current input terminal 1402a, a current output terminal 1402b, and a signal input terminal 1402c. One end of the inductor 1401 is electrically connected with a positive terminal of the external power source 300, and the other end of the inductor 1401 is electrically connected with the current input terminal 1402a of the second switch module 1402. The current output terminal 1402b of the second switch module 1402 is electrically connected with a negative terminal of the external power source 300 as well as the ground, and the signal input terminal 1402c of the second switch module 1402 is electrically connected with the signal output terminal 113 of the constant current driving unit 110. The constant current driving unit 110 outputs the boosting signal S_{L} to the signal input terminal 1402c of the second switch module 1402 from the signal output terminal 113 according to the voltage of the negative terminal of the load 200 detected by the first terminal 114 of the constant current driving unit 110. When the boosting signal S_{L} is at a high level, the second switch module 1402 is turned on, and the inductor 1401 is charged to boost the voltage. When the boosting signal S_{L} is at a low level, the second switch module 1402 is turned off, and the inductor 1401 is discharged to drive the load 200. The boosting circuit 140 can boost the first driving voltage V₁ to the second driving voltage V₂ through controlling the boosting signal S_{L}.

In this embodiment, the first filter circuit 160 is electrically connected with the boosting circuit 140 and the load 200 respectively, and the first filter circuit 160 comprises a rectifying diode 1601 and a capacitor 1602. The first filter circuit 160 is utilized for filtering the voltage boosted by the boosting circuit 140.

The object of the present invention is to adjust the current value of the load current I_{L} outputted to the load 200, so that the load current I_{L} can be adjusted to various values and duty cycles.

Please refer again to FIG. 2 in conjunction with FIG. 1. In this embodiment, the constant current driving unit 110 comprises a circuit divider 1101, a comparing circuit 1102, and a first switch module 1103. One end of the circuit divider 1101 is electrically connected with the voltage input terminal 111, and the other end of the circuit divider 1101 is grounded. The comparing circuit 1102 is electrically connected with the circuit divider 1101 and the signal input terminal 112. The first switch module 1103 is electrically connected with the comparing circuit 1102, the first terminal 114, and the second terminal 115 respectively. The voltage input unit 120 is electrically connected with the voltage input terminal 111, and the PWM signal input unit 130 is electrically connected with the signal input terminal 112. The voltage input unit 120 inputs the input voltage Vᵢₙ to the constant current driving unit 110 through the voltage input terminal 111, and the input voltage Vᵢₙ is divided into the reference voltage V. In this embodiment, the input voltage Vᵢₙ is an ADIM (analog dimming input) voltage, and the voltage input terminal 111 is an ADIM terminal.

In this embodiment, the input voltage Vᵢₙ is a pulse or a square waveform having an adjustable duty cycle, and the voltage input unit 120 comprises a second filter circuit 1201. The second filter circuit 1201 is not limited to comprise a resistor and a capacitor. The second filter circuit 1201 is utilized for filtering the input voltage Vᵢₙ having different duty cycles to different DC voltages, therefore, the reference voltage V can be adjusted. The second terminal of the constant current driving unit 110 is electrically connected with the first resistor 150, and the constant current driving unit 110 detects the voltage on the first resistor 150 through the second terminal 115, and a resultant of the load current I_{L} which is passed through the load 200 and the voltage on the first resistor 150 is a comparing voltage V_{R}. When the load 200 is turned on, the reference voltage V and the comparing voltage V_{R} are compared by the comparing circuit 1102. If the comparing voltage V_{R} is lower than the reference voltage V, the load current I_{L} is too low, so that the impedance of the first switch module 1103 inside the constant current driving unit 110 is decreased, and the load current I_{L} is increased. If the comparing voltage V_{R} is higher than the reference voltage V, the load current I_{L} is too high, so that the impedance of the first switch module 1103 inside the constant current driving unit 110 is increased, and the load current I_{L} is decreased. Thus, the load current I_{L} can be set as a pre-set current value and be stable.

In addition, the input voltage Vᵢₙ can be filtered to various stable voltage values by inputting the input voltage Vᵢₙ having an adjustable duty cycle and corresponding parameters of the second filter circuit 1201 can be chosen, so that the various values of the reference voltage V is obtained. The value of the load current I_{L} can be adjusted within a range which is sustainable by the load 200 according to the different values of the reference voltage V. Using LED series for example, the sustained current range of the LED series is 0 mA˜350 mA. Thus, the current range of the load current I_{L} can be increased effectively.

Furthermore, the PWM signal input unit 130 inputs the PWM signal S_{P} to the constant current driving unit 110 through the signal input terminal 112. When the PWM signal S_{P} is at a high level, the first switch module 1103 is turned on, and the load current I_{L} passes through the load 200. When the PWM signal S_{P} is at a low level, the first switch module 1103 is turned off, and the load current I_{L} does not pass through the load 200. Therefore, the waveform of the load current I_{L} can be adjusted to the same as the waveform of the PWM signal S_{P}, and an effect of adjusting the current is achieved.

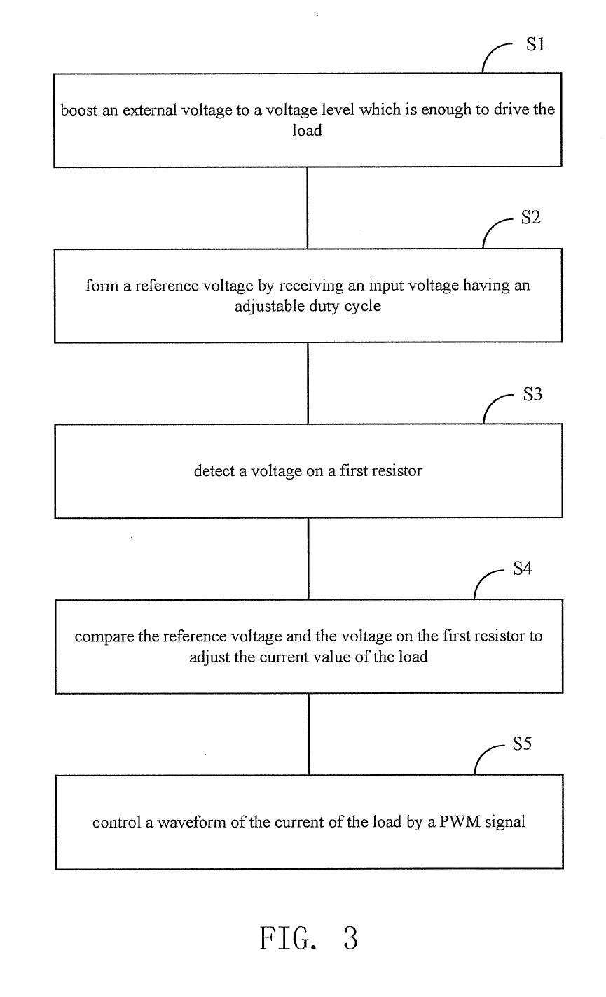

Please refer to FIG. 3. FIG. 3 illustrates a flow chart of a current adjustment method according to another embodiment of the present invention.

In the step S1, an external voltage is boosted to a voltage level which is enough to drive a load. In the present embodiment, a boosting circuit is utilized to boost the external voltage to drive the load.

In the step S2, a reference voltage is formed by receiving an input voltage having an adjustable duty cycle. In this embodiment, the input voltage is a pulse, and the pulse is not limited to be a pulse waveform having an adjustable duty cycle, and the input voltage is divided into the reference voltage. In addition, the input voltage can be filtered to various stable voltage values by inputting the input voltage having an adjustable duty cycle and corresponding parameters of a filter circuit is chosen, so that the various values of the reference voltage can be obtained.

In the step S3, a voltage on a first resistor is detected. The first resistor is electrically connected with the load through a constant current driving unit.

In the step S4, the reference voltage and the voltage on the first resistor are compared to adjust the current value of the load. In this embodiment, if the comparing voltage is lower than the reference voltage, the load current is too low, so that the load current I_{L} is increased; if the comparing voltage is higher than the reference voltage, the load current is too high, so that the load current I_{L} is decreased. Thus, the required value of the load current can be obtained by comparing the voltages.

In this embodiment, the current adjusting method further comprises the step S5. In the step S5, the waveform of the load current is controlled by a PWM signal. In this embodiment, the PWM signal is a pulse waveform having an adjustable duty cycle, the waveform of the load current can be adjusted to be the same as the waveform of the PWM signal based on when the PWM signal is at a high level or low level, and an effect of adjusting current is achieved.

The current adjusting device and method of the present invention can achieve a double adjusting of the input voltage and the PWM signal, so that the value and duty cycle of the load current can be adjusted linearly in conjunction with various combinations of current values and duty cycles, thereby various values and duty cycles of the load current can be obtained.

To sum up, the present invention has been disclosed as the preferred embodiments above, however, the above preferred embodiments are not described for limiting the present invention, various modifications, alterations and improvements can be made by persons skilled in this art without departing from the spirits and principles of the present invention, and therefore the protection scope of claims of the present invention is based on the range defined by the claims.

What is claimed is:

1. A current adjusting device for adjusting a current value outputted to a load, wherein the current adjusting device comprises:
an ADIM (analog dimming input) voltage input unit for providing an ADIM voltage, a waveform of which is a pulse waveform having an adjustable duty cycle and filtered to a DC voltage; and
a constant current driving unit electrically connected with the ADIM voltage input unit, a negative terminal of the load and a first resistor, respectively, comprising a comparing module and a first switch module, wherein the constant current driving unit receives the ADIM voltage having the adjustable duty cycle to form a reference voltage, and the constant current driving unit adjusts an impedance of the first switch module by the comparing module comparing the reference voltage and a voltage on the first resistor to determine the current value of the load.

2. The current adjusting device of claim 1, further comprising a PWM (pulse width modulation) signal input unit electrically connected with the constant current driving unit and used for inputting a PWM signal to the constant current driving unit so that the constant current driving unit receives the PWM signal to control a close or an open of the first switch module for controlling a waveform of a load current.

3. The current adjusting device of claim 1, further comprising a circuit divider for dividing the DC voltage into the reference voltage.

4. The current adjusting device of claim 1, further comprising a boost circuit electrically connected with a positive terminal of the load and an external power source, and the constant current driving unit detecting a voltage of the negative terminal of the load and accordingly outputting a boost signal having duty cycle to boost an external voltage provided by the external power source so that the load is driven, wherein the duty cycle of the boost signal is adjusted based on the voltage detected on the negative terminal of the load by the constant current driving unit.

5. A current adjusting device for adjusting a current value outputted to a load, and the current adjusting device comprising:
a constant current driving unit electrically connected with a negative terminal of the load and a first resistor, respectively, comprising a comparing module and a first switch module, wherein the constant current driving unit detects a voltage of the negative terminal of the load and accordingly outputs a boost signal, and the constant current driving unit receives a PWM signal to control a close or an open of the first switch module for controlling a current waveform of the load, and the constant current driving unit receives an input voltage having an adjustable duty cycle to form a reference voltage and adjusts an impedance of the first switch module by the comparing module comparing the reference voltage and a voltage on the first resistor to determine the current value of the load; and
a boost circuit, electrically connected with a positive terminal of the load and an external power source, boosting an external voltage provided by the external power source to drive the load according to the boost signal.

6. The current adjusting device of claim 5, further comprising a circuit divider for dividing the input voltage into the reference voltage.

7. The current adjusting device of claim 5, further comprising:
a voltage input unit electrically connected with the constant current driving unit and used for inputting the input voltage as a pulse waveform having an adjustable duty cycle to the constant current driving unit; and
a PWM signal input unit electrically connected with the constant current driving unit and used for inputting the PWM signal to the constant current driving unit.

8. The current adjusting device of claim 7, wherein the voltage input unit comprises a second filter circuit utilized to filter the pulse waveform inputted to the constant current driving unit.

9. The current adjusting device of claim 5, wherein the constant current driving unit detects the voltage on the negative terminal of the load and accordingly outputs the boost signal having a duty cycle to the boost circuit according to the voltage detected on the negative terminal of the load, the duty cycle of the boost signal is adjusted based on the voltage detected on the negative terminal of the load by the constant current driving unit.

10. A current adjusting method for adjusting a current value outputted to a load, wherein the current adjusting method comprises:
boosting an external voltage to a voltage level which is enough to drive the load;
forming a reference voltage by receiving an input voltage having an adjustable duty cycle;
detecting a voltage on a first resistor electrically connected with the load through a constant current driving unit; and
comparing the reference voltage and the voltage on the first resistor to adjust the current value of the load.

11. The current adjusting method of claim 10, wherein the input voltage is a pulse waveform having an adjustable duty cycle.

12. The current adjusting method of claim 11, wherein the pulse waveform is formed by filtering.

13. The current adjusting method of claim 10, further comprising: controlling a waveform of the load current by a PWM signal.
